(19) United States
(12) Patent Application Publication
(10) Pub. No.: US 2026/0135497 A1
(43) Pub. Date: May 14, 2026

(54) CONTROL DEVICE AND ROBOT

(71) Applicant: SEIKO EPSON CORPORATION, Tokyo (JP)

(72) Inventors: Hidetoshi SAITO, FUJIMI-MACHI (JP); Takao MIYAZAWA, SHIMOSUWA-MACHI (JP); Ryuichi SATO, MATSUMOTO-SHI (JP)

(21) Appl. No.: 19/383,336

(22) Filed: Nov. 7, 2025

(30) Foreign Application Priority Data
Nov. 8, 2024 (JP) 2024-195770

(51) Int. Cl. H02N 2/02; B25J 9/10; H02N 2/06; H02N 2/14

(52) U.S. Cl. CPC H02N 2/026; B25J 9/10; H02N 2/062; H02N 2/142

(57) ABSTRACT

A control device is provided in a drive device including a vibrating body and a contact body in contact with the vibrating body. The control device is configured to cause the vibrating body and the contact body to move relative to each other. A period from start of the relative movement until the contact body reaches a target stop position includes a first period and a second period subsequent to the first period. The control device controls, in the first period, drive of the vibrating body based on a difference between a first target position located before the target stop position and a current position and an actual velocity of the relative movement, and controls, in the second period, the drive of the vibrating body based on a difference between the current position and a second target position located closer to the target stop position and any virtual velocity.

### CROSS-REFERENCE TO RELATED APPLICATIONS

The present application is based on, and claims priority from JP Application Serial Number 2024-195770, filed November 8, 2024, the disclosure of which is hereby incorporated by reference herein in its entirety.

### BACKGROUND OF THE INVENTION

### 1. Technical Field

The present disclosure relates to a control device and a robot.

### 2. Related Art

JP-A-2021-019399 describes a relative movement unit that includes a vibrating body including a piezoelectric element, a contact body that is in contact with the vibrating body, and a drive control unit that controls drive of the vibrating body. The drive control unit drives the vibrating body with an alternating current signal to cause the contact body to move relative to the vibrating body. Further, the drive control unit controls a pulse duty of a signal to be converted into the alternating current signal, based on a difference between a target stop position, which is a final stop position of the contact body, and a current position of the contact body, and an actual velocity of the contact body.

However, since an actual velocity of the contact body is considerably reduced at the final stage of positioning, that is, near the target stop position, fluctuations in the velocity of the moving body are more likely to occur in a method in which the contact body is moved relative to the vibrating body by friction with the vibrating body. Therefore, when the contact body is made to approach the target stop position based on the actual velocity, reciprocating movement across the target stop position, stopping before the target stop position, and the like are more likely to occur, making it difficult to stop the contact body at the target stop position in a short time.

### SUMMARY OF THE INVENTION

A control device according to the present disclosure is a control device in a drive device including a vibrating body and a contact body in contact with the vibrating body, the control device being configured to cause the vibrating body and the contact body to perform relative movement to each other by vibrating the vibrating body, in which a period from start of the relative movement until the contact body reaches a target stop position includes a first period and a second period subsequent to the first period, the control device controls, in the first period, drive of the vibrating body based on a difference between a first target position located before the target stop position and a current position, and an actual velocity of the relative movement, and the control device controls, in the second period, the drive of the vibrating body based on a difference between the current position and a second target position located closer to the target stop position than is the first target position, and any virtual velocity that is set for the relative movement.

A robot according to the present disclosure includes a movable stage that includes a vibrating body, a contact body in contact with the vibrating body, and a control device that causes the vibrating body and the contact body to perform relative movement to each other by vibrating the vibrating body, in which a period from start of the relative movement until the contact body reaches a target stop position includes a first period and a second period subsequent to the first period, and the control device controls, in the first period, drive of the vibrating body based on a difference between a first target position located before the target stop position and a current position, and an actual velocity of the relative movement, and controls, in the second period, the drive of the vibrating body based on a difference between the current position and a second target position located closer to the target stop position than is the first target position, and any virtual velocity that is set for the relative movement.

### BRIEF DESCRIPTION OF DRAWINGS

FIG. 1 is a plan view of a drive device according to a first embodiment.

FIG. 2 is a diagram showing an example of a drive signal applied to a piezoelectric actuator.

FIG. 3 is a plan view showing a driving state of the piezoelectric actuator.

FIG. 4 is a block diagram showing a configuration of a control device.

FIG. 5 is a graph showing an example of a movement plan of a slider.

FIG. 6 is a graph showing an example of a position profile created by converting the movement plan.

FIG. 7 is a block diagram showing a method of controlling the piezoelectric actuator in a first period.

FIG. 8 is a graph showing an example of a method of determining a virtual velocity Vi.

FIG. 9 is a block diagram showing a method of controlling the piezoelectric actuator in a second period.

FIG. 10 is a block diagram showing a method of controlling the piezoelectric actuator in a third period.

FIG. 11 is a block diagram showing a method of controlling the piezoelectric actuator in the second period when a velocity Ve1 is higher than an assumed range.

FIG. 12 is a block diagram showing a method of controlling the piezoelectric actuator in the second period when the velocity Ve1 is lower than the assumed range.

FIG. 13 is a graph showing an example of a position profile according to a third embodiment.

FIG. 14 is a block diagram showing a method of controlling the piezoelectric actuator in the second period.

FIG. 15 is a side view showing a robot according to a fourth embodiment.

FIG. 16 is a plan view showing a movable stage.

### DETAILED DESCRIPTION OF THE INVENTION

Hereinafter, a control device and a robot according to the present disclosure will be described in detail based on preferred embodiments shown in the accompanying drawings.

### First Embodiment

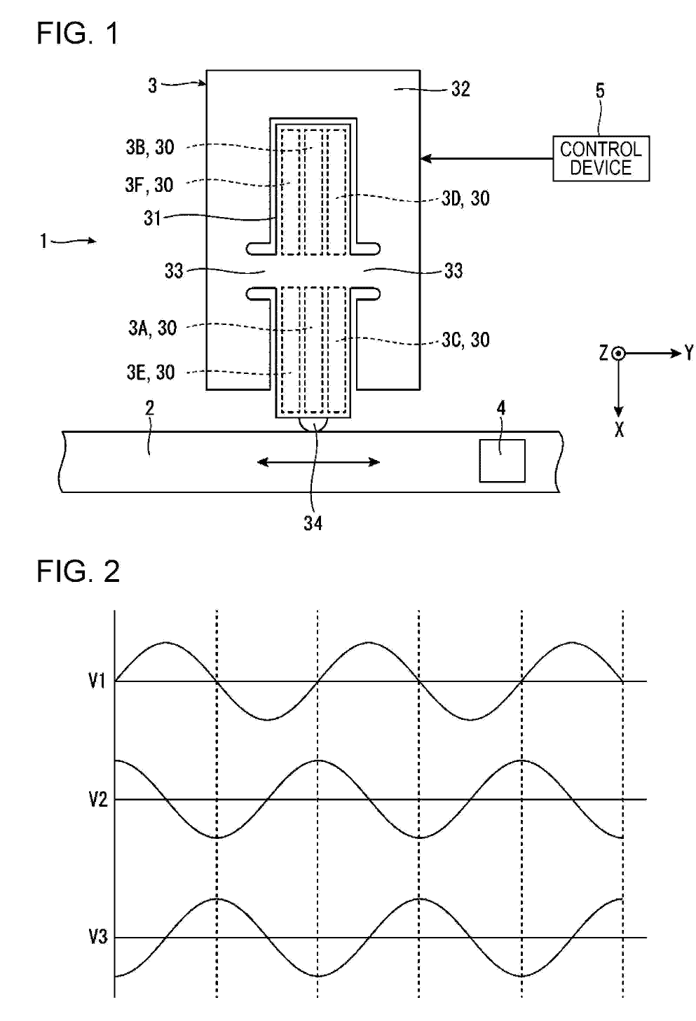

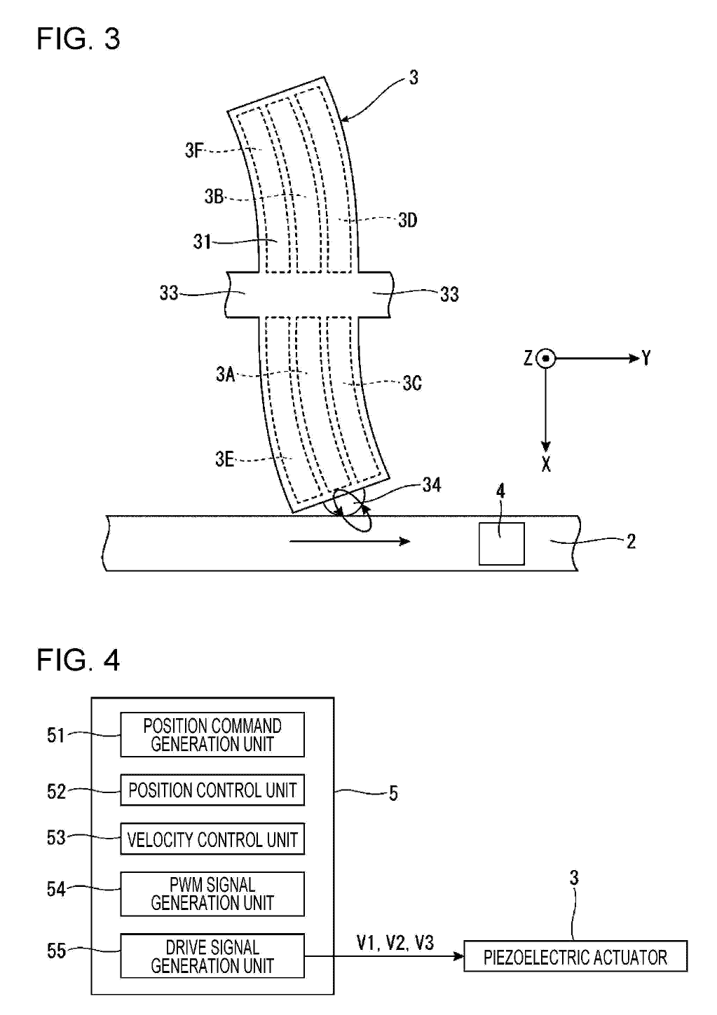

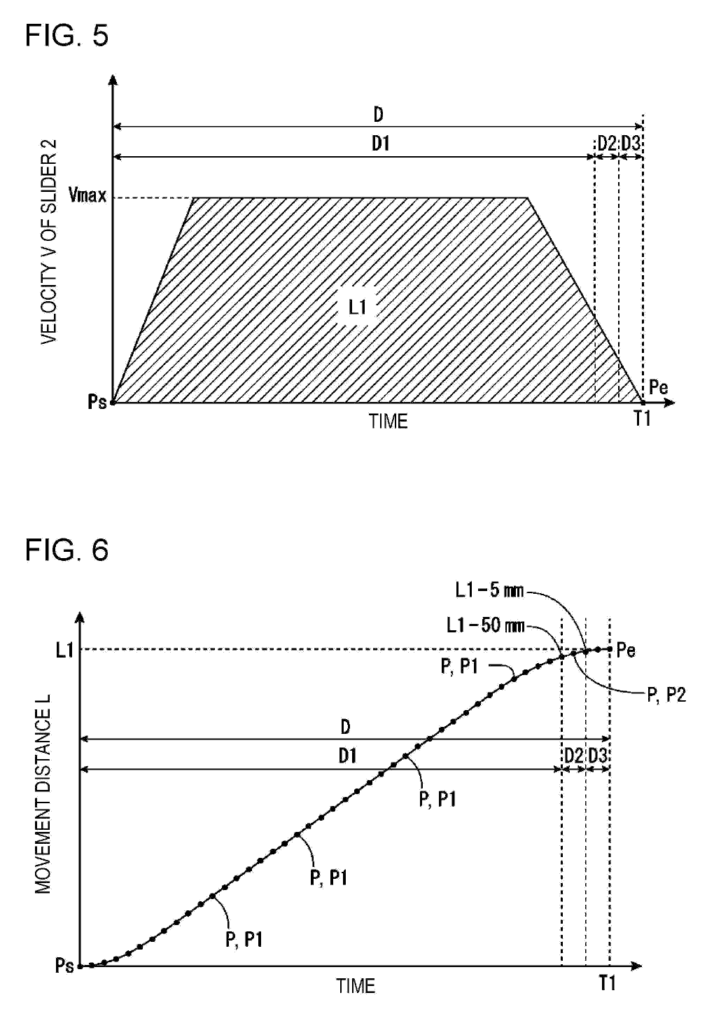

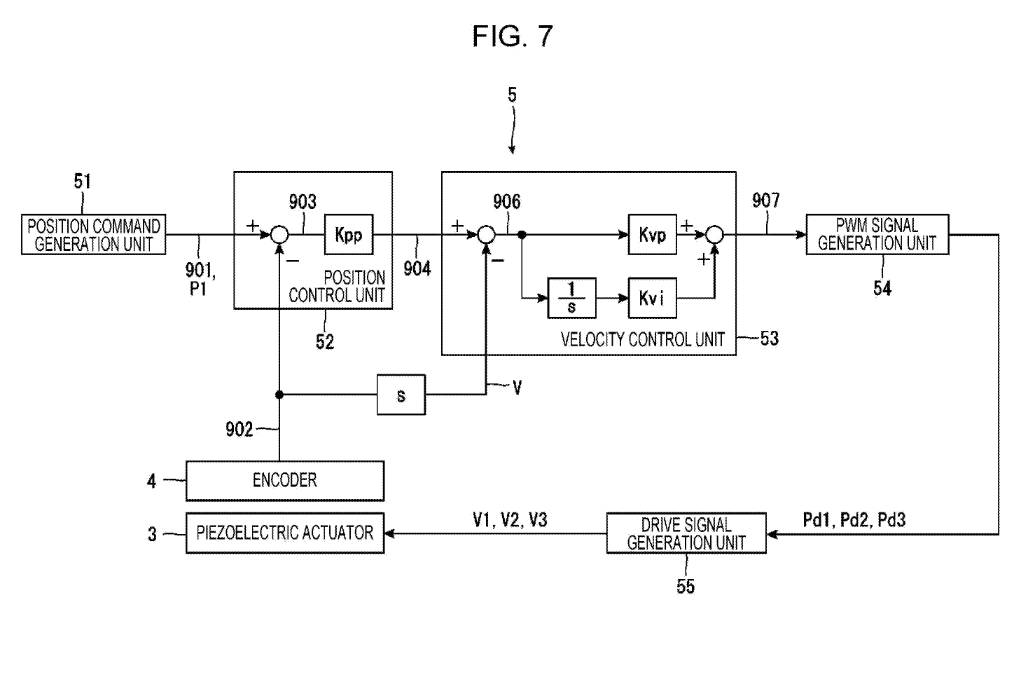

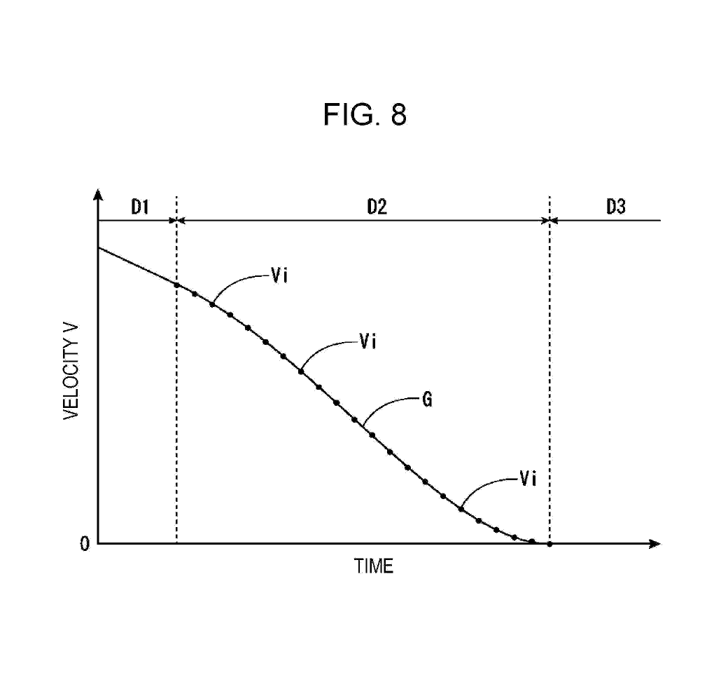

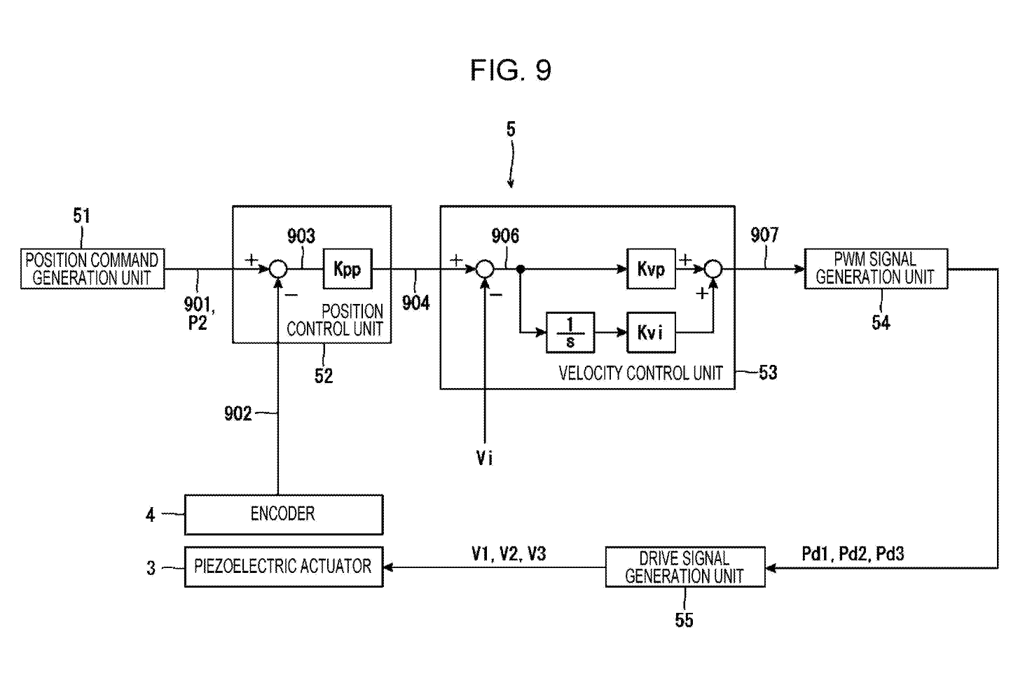

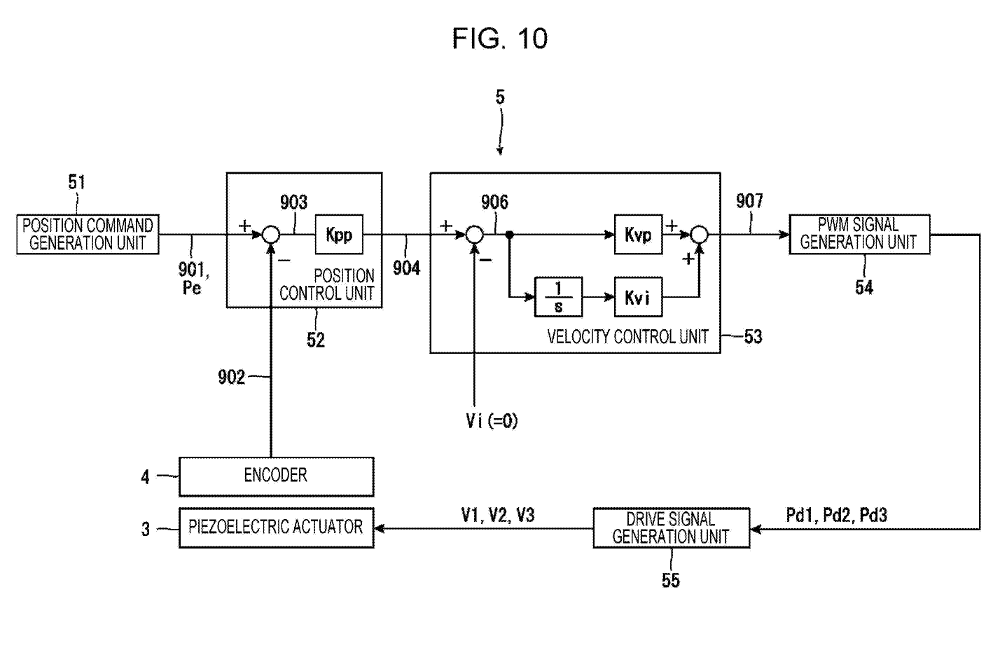

FIG. 1 is a plan view of a drive device according to a first embodiment. FIG. 2 is a diagram showing an example of a drive signal applied to a piezoelectric actuator. FIG. 3 is a plan view showing a driving state of the piezoelectric actuator. FIG. 4 is a block diagram showing a configuration of a control device. FIG. 5 is a graph showing an example of a movement plan of a slider. FIG. 6 is a graph showing an example of a position profile created by converting the movement plan. FIG. 7 is a block diagram showing a method of controlling the piezoelectric actuator in a first period. FIG. 8 is a graph showing an example of a method of determining a virtual velocity Vi. FIG. 9 is a block diagram showing a method of controlling the piezoelectric actuator in a second period. FIG. 10 is a block diagram showing a method of controlling the piezoelectric actuator in a third period.

Hereinafter, as shown in FIGS. 1 and 3, three axes orthogonal to each other are referred to as an X-axis, a Y-axis, and a Z-axis, and a direction along the X-axis is referred to as an X-axis direction, a direction along the Y-axis is referred to as a Y-axis direction, and a direction along the Z-axis is referred to as a Z-axis direction. An arrow side of each axis is also referred to as a "positive side", and a side opposite to the arrow is also referred to as a "negative side". The positive side in the Z-axis direction is also referred to as "up", the negative side in the Z-axis direction is also referred to as "down", the positive side in the X-axis direction is also referred to as "distal end", and the negative side in the X-axis direction is also referred to as "proximal end".

A drive device 1 shown in FIG. 1 includes a slider 2 as a contact body which linearly moves in the X-axis direction, a piezoelectric actuator 3 as a vibrating body which moves the slider 2 in the X-axis direction, an encoder 4 which detects a position of the slider 2, and a control device 5 which controls the drive of the piezoelectric actuator 3. However, the configuration of the drive device 1 is not particularly limited. For example, a plurality of piezoelectric actuators 3 may be disposed for the slider 2, and the slider 2 may be slid by the drive of the plurality of piezoelectric actuators 3. In addition, the contact body is not limited to a sliding body that slides like the slider 2, and may be a rotating body such as a rotor that rotates around the Z-axis, for example.

The piezoelectric actuator 3 includes a vibrating portion 31, a support portion 32 which supports the vibrating portion 31, a pair of beam portions 33 which couples the vibrating portion 31 and the support portion 32, and a protruding portion 34 which is disposed at a distal end portion of the vibrating portion 31.

In addition, the vibrating portion 31 has a rectangular shape, with the X-axis direction as a longitudinal direction, in plan view from the Z-axis direction. The vibrating portion 31 performs S-shaped flexural vibration in the Y-axis direction while performing expansion and contraction vibration in the X-axis direction. The vibrating portion 31 includes a piezoelectric element 30 for vibrating the vibrating portion 31 as described above. The piezoelectric element 30 includes piezoelectric elements 3A and 3B that cause the vibrating portion 31 to perform expansion and contraction vibration in the X-axis direction, and piezoelectric elements 3C, 3D, 3E, and 3F that cause the vibrating portion 31 to perform S-shaped flexural vibration in the Y-axis direction. Among these, the piezoelectric elements 3A and 3B are disposed side by side in the X-axis direction at a central portion of the vibrating portion 31. The piezoelectric elements 3C and 3D are disposed side by side in the X-axis direction on the positive side of the piezoelectric elements 3A and 3B in the Y-axis direction. On the other hand, the piezoelectric elements 3E and 3F are disposed side by side in the X-axis direction on the negative side of the piezoelectric elements 3A and 3B in the Y-axis direction. Each of the piezoelectric elements 3A to 3F expands and contracts in the X-axis direction by energization. However, the number and disposition of the piezoelectric elements 30 are not particularly limited.

The protruding portion 34 is provided at the distal end portion of the vibrating portion 31. The distal end portion of the protruding portion 34 is pressed against the slider 2 by a biasing member (not shown). In addition, the support portion 32 has a U shape surrounding three sides of both sides and the rear of the vibrating portion 31. The pair of beam portions 33 couples the vibrating portion 31 and the support portion 32.

In the piezoelectric actuator 3 having such a configuration, for example, when a drive signal V1 is applied to the piezoelectric elements 3A and 3B, a drive signal V2 is applied to the piezoelectric elements 3C and 3F, and a drive signal V3 is applied to the piezoelectric elements 3D and 3E, as shown in FIG. 2, the vibrating portion 31 performs expansion and contraction vibration in the X-axis direction and, at the same time, performs inverse S-shaped flexural vibration in the Y-axis direction, as shown in FIG. 3. These vibrations are synthesized, and the distal end of the protruding portion 34 performs elliptical motion along an elliptical trajectory in a counterclockwise direction, as indicated by the arrow, while repeatedly making contact with and separating from the slider 2. As a result, the slider 2 is fed and moved to the positive side in the Y-axis direction. On the other hand, when the waveforms of the drive signals V2 and V3 are switched, the distal end of the protruding portion 34 performs elliptical motion in the opposite direction, and the slider 2 moves to the negative side in the Y-axis direction. A velocity V of the slider 2 can be controlled by the amplitudes of the drive signals V2 and V3. Specifically, as the amplitudes of the drive signals V2 and V3 increase, the velocity V of the slider 2 increases, and as the amplitudes of the drive signals V2 and V3 decrease, the velocity V of the slider 2 decreases.

The piezoelectric actuator 3 has been described above, but the configuration of the piezoelectric actuator 3 is not particularly limited. For example, a single piezoelectric actuator 3 may be configured by stacking a plurality of piezoelectric actuators 3. As a result, the piezoelectric actuator 3 can exhibit a greater driving force. The vibrating body is not limited to the piezoelectric actuator 3.

As shown in FIG. 4, the control device 5 includes a position command generation unit 51, a position control unit 52, a velocity control unit 53, a pulse width modulation (PWM) signal generation unit 54, and a drive signal generation unit 55. Then, in the control device 5, the velocity V of the slider 2 is controlled so that the slider 2 reaches a target position in each control period. The velocity V of the slider 2 depends on the amplitudes of the drive signals V2 and V3, and does not substantially depend on the amplitude of the drive signal V1. Therefore, the control device 5 controls the velocity V of the slider 2 by controlling the amplitudes of the drive signals V2 and V3 while keeping the amplitude of the drive signal V1 constant. However, a method of controlling the velocity V is not particularly limited. The control device 5 is formed of, for example, a computer, and includes a processor that processes information, a memory that is communicably connected to the processor, and an external interface. In addition, a program which can be executed by the processor is stored in the memory, and the processor reads and executes the program stored in the memory, whereby the functions of the respective units are exhibited.

First, the control device 5 acquires, from a host computer or the like (not shown), a target stop position Pe to which the slider 2 is to be moved, that is, a movement distance L1 which is a total movement distance of the slider 2 from a movement start position Ps to the target stop position Pe, and a movement time T1 which is a total movement time from the movement start position Ps to the target stop position Pe.

Then, the control device 5 sets a movement plan of the slider 2 from the movement start position Ps to the target stop position Pe as shown in FIG. 5, for example, based on the maximum velocity Vmax of the slider 2 set in advance and the acquired information. In FIG. 5, a horizontal axis represents time, a vertical axis represents the velocity V of the slider 2, and an area of the hatched portion corresponds to the movement distance L1. The movement plan shown in FIG. 5 includes an acceleration period in which the slider 2 is accelerated to the maximum velocity Vmax, a constant-velocity period in which the slider 2 is maintained at the maximum velocity Vmax, and a deceleration period in which the slider 2 is decelerated and stopped at the target stop position Pe, but the movement plan is not limited thereto. For example, when the movement distance of the slider 2 is short, the constant-velocity period may be omitted, and deceleration may be started before the slider 2 is accelerated to the maximum velocity Vmax.

Next, as shown in FIG. 5, the control device 5 divides a period D from when the slider 2 starts to move from the movement start position Ps to when the slider 2 reaches the target stop position Pe into three periods of a first period D1, a second period D2 subsequent to the first period D1, and a third period D3 subsequent to the second period D2. The first period D1 is set as a period in which the velocity V of the slider 2 is sufficiently high and the movement of the slider 2 is stable. On the other hand, each of the second and third periods D2 and D3 is set as a period in which the velocity V of the slider 2 is low and the movement of the slider 2 is more likely to be unstable.

A method of determining the first period D1 is not particularly limited. For example, the method is determined based on at least one of (a) the velocity V of the slider 2, that is, the velocity of the relative movement between the piezoelectric actuator 3 and the slider 2, (b) the movement distance L of the slider 2 from the movement start position Ps, and (c) the movement time T of the slider 2 from the movement start time.

In the case of the method of determining the first period D1 based on the above (a), for example, a period from when the slider 2 starts to move to when the velocity V reaches A1% of the maximum velocity Vmax in the deceleration period can be set as the first period D1. According to such a method, it is possible to easily and appropriately determine the first period D1. Any A1 can be set by a user, but is preferably set to, for example, 1% or more and 20% or less, more preferably set to 5% or more and 15% or less, and still more preferably set to about 10%. According to such numerical values, it is possible to ensure a sufficiently long first period D1 while avoiding a period in which the movement of the slider 2 becomes unstable.

As another method of determining the first period D1 based on the above (a), for example, a period from when the slider 2 starts to move to when the velocity V reaches A2 mm/s in the deceleration period can be set as the first period D1. That is, in the present method, the first period D1 is determined using an absolute value of the velocity V instead of a relative value with respect to the maximum velocity Vmax as described above. However, A2 < Vmax. According to such a method, it is possible to easily and appropriately determine the first period D1. Any A2 can be set by the user, but is preferably set to, for example, 10 mm/s or more and 100 mm/s or less, more preferably set to 20 mm/s or more and 50 mm/s or less, and still more preferably set to about 30 mm/s. According to such numerical values, it is possible to ensure a sufficiently long first period D1 while avoiding a period in which the movement of the slider 2 becomes unstable.

In the case of the method of determining the first period D1 based on the above (b), for example, a period from when the slider 2 starts to move to when the movement distance L of the slider 2 reaches A3% of the movement distance L1 which is the total movement distance can be set as the first period D1. According to such a method, it is possible to easily and appropriately determine the first period D1. Any A3 can be set by a user, but is preferably set to, for example, 80% or more and 95% or less, more preferably set to 85% or more and 95% or less, and still more preferably set to about 90%. According to such numerical values, it is possible to ensure a sufficiently long first period D1 while avoiding a period in which the movement of the slider 2 becomes unstable.

In addition, as another method of determining the first period D1 based on the above (b), for example, a period from when the slider 2 starts to move to when the movement distance L1 of the slider 2 reaches A4 mm can be set as the first period D1. That is, in the present method, the first period D1 is determined using an absolute value of the movement distance L instead of a relative value with respect to the movement distance L1 which is the total movement distance as described above. However, A4 < L1. According to such a method, it is possible to easily and appropriately determine the first period D1. Any A4 can be set by the user, but is preferably set to, for example, 10 mm or more and 100 mm or less, more preferably set to 20 mm or more and 80 mm or less, and still more preferably set to about 50 mm. According to such numerical values, it is possible to ensure a sufficiently long first period D1 while avoiding a period in which the movement of the slider 2 becomes unstable.

In the case of the method of determining the first period D1 based on the above (c), for example, a period from when the slider 2 starts to move to when the movement time T of the slider 2 reaches A5% of the movement time T1, which is the total movement time, can be set as the first period D1. According to such a method, it is possible to easily and appropriately determine the first period D1. Any A5 can be set by the user, but is preferably set to, for example, 80% or more and 95% or less, more preferably set to 85% or more and 95% or less, and still more preferably set to about 90%. According to such numerical values, it is possible to ensure a sufficiently long first period D1 while avoiding a period in which the movement of the slider 2 becomes unstable.

In addition, as another method of determining the first period D1 based on the above (c), for example, a period from when the slider 2 starts to move to when the movement time T of the slider 2 reaches A6 seconds can be set as the first period D1. In other words, in the present method, the first period D1 is determined using the absolute value of the movement time T instead of the relative value of the movement time T1, which is the total movement time as described above. However, A6 < T1. According to such a method, it is possible to easily and appropriately determine the first period D1. Any A6 can be set by the user, but for example, (T1 - A6) is preferably set to 0.1 seconds or more and 1.0 seconds or less, more preferably set to 0.3 seconds or more and 0.7 seconds or less, and still more preferably set to about 0.5 seconds.

The method of determining the first period D1 has been described above. The first period D1 may be determined by combining two or more of (a), (b), and (c) described above. For example, by combining (a) and (b), a period until the velocity V becomes equal to or less than A1% of the maximum velocity Vmax and the movement distance L of the slider 2 becomes equal to or less than A3% of the movement distance L1 may be set as the first period D1.

Next, a method of determining the second period D2 will be described. The method of determining the second period D2 is not particularly limited, but the second period D2 is determined based on, for example, at least one of (a) the velocity V of the slider 2, (b) the movement distance L of the slider 2, and (c) the movement time T of the slider 2, similarly to the above-described method of determining the first period D1.

In the case of the method of determining the second period D2 based on the above (a), for example, a period from the end of the first period D1 to a point in time when the velocity V reaches B1% of the maximum velocity Vmax can be set as the second period D2. However, B1 < A1. Any B1 can be set by the user. According to such a method, it is possible to easily and appropriately determine the second period D2.

Further, as another method of determining the second period D2 based on the above (a), for example, a period from the end of the first period D1 to a point in time when the velocity V reaches B2 mm/s can be set as the second period D2. However, B2 < A2. Any B2 can be set by the user. According to such a method, it is possible to easily and appropriately determine the second period D2.

In the case of the method of determining the second period D2 based on the above (b), for example, a period from the end of the first period D1 to a point in time when the movement distance L of the slider 2 reaches B3% of the movement distance L1 can be set as the second period D2. However, A3 < B3 < 100. Any B3 can be set by the user. According to such a method, it is possible to easily and appropriately determine the second period D2.

In addition, as another method of determining the second period D2 based on the above (b), for example, a period from the end of the first period D1 to a point in time when the movement distance L of the slider 2 reaches B4 mm can be set as the second period D2. However, A4 < B4 < L1. Any B4 can be set by the user. According to such a method, it is possible to easily and appropriately determine the second period D2.

In the case of the method of determining the second period D2 based on the above (c), for example, a period from the end of the first period D1 to a point in time when the movement time T of the slider 2 reaches B5% of the movement time T1 can be set as the second period D2. However, A5 < B5 < 100. Any B5 can be set by the user. According to such a method, it is possible to easily and appropriately determine the second period D2.

In addition, as another method of determining the second period D2 based on the above (c), for example, a period from the end of the first period D1 to a point in time when the movement time T of the slider 2 reaches B6 seconds can be set as the second period D2. However, A6 < B6 < T1. Any B6 can be set by the user. According to such a method, it is possible to easily and appropriately determine the second period D2.

The method of determining the second period D2 has been described above. Similarly to the method of determining the first period D1, the second period D2 may be determined by combining two or more of (a), (b), and (c) described above.

Next, a method of determining the third period D3 will be described. The method of determining the third period D3 is not particularly limited. For example, a period from the end of the second period D2 to a point in time when the slider 2 reaches the target stop position Pe can be set as the third period D3. According to such a method, it is possible to easily and appropriately determine the third period D3.

The methods of determining the first, second, and third periods D1, D2, and D3 have been described above. The control device 5 then converts the movement plan shown in FIG. 5 into the position profile shown in FIG. 6. Then, the control device 5 uses the converted position profile to determine the first, second, and third periods D1, D2, and D3 based on the above (b), that is, by a method based on the movement distance L of the slider 2. In the shown example, the end time of the first period D1 is set to the time of the movement distance L = L1 - 50 mm, and the end time of the second period D2 is set to the time of the movement distance L = L1 - 5 mm. However, the present disclosure is not limited thereto. The first, second, and third periods D1, D2, and D3 may be determined by the above-described (a) or (c), or other methods.

The control device 5 determines a target position P of the slider 2 for each control period based on the converted graph. Hereinafter, among the set target positions P, a target position located within the first period D1 is also referred to as a "first target position P1", and a target position P located within the second period D2 is also referred to as a "second target position P2". Accordingly, the first and second target positions P1 and P2 are located before the target stop position Pe, and the second target position P2 is located closer to the target stop position Pe than is the first target position P1.

Then, the control device 5 controls the drive of the piezoelectric actuator 3 as follows in the first period D1. In the first period D1, the control device 5 controls the drive of the piezoelectric actuator 3 based on a difference between the first target position P1 and the current position of the slider 2, and the velocity V of the slider 2.

Specifically, as shown in FIG. 7, the position command generation unit 51 specifies the first target position P1 of the corresponding control period from the first target position P1 of each control period determined as described above, and generates a position command 901 in which the specified first target position P1 is determined. The first target position P1 is updated in each control period. First, the position control unit 52 obtains a position deviation 903 by subtracting a position 902 of the slider 2 detected by the encoder 4 from the position command 901. Next, the position control unit 52 obtains a velocity command 904 by multiplying the position deviation 903 by a position loop proportional gain Kpp.

The velocity control unit 53 is configured with proportional-integral control, and obtains a voltage command 907 for causing the velocity V of the slider 2, which is obtained by time-differentiating the position 902 of the slider 2, to coincide with the velocity command 904. Specifically, the velocity control unit 53 first subtracts the velocity V from the velocity command 904 to obtain a velocity loop command 906. Next, the velocity control unit 53 obtains the voltage command 907 by adding an integral term, which is obtained by multiplying an integral value of the velocity loop command 906 by a velocity loop integral gain Kvi, to a proportional term, which is obtained by multiplying the velocity loop command 906 by a velocity loop proportional gain Kvp.

The PWM signal generation unit 54 generates a pulse width command having a duty corresponding to the voltage command 907. The pulse width command includes a pulse signal Pd1 for the drive signal V1, a pulse signal Pd2 for the drive signal V2, and a pulse signal Pd3 for the drive signal V3. The drive signal generation unit 55 generates sinusoidal drive signals V1, V2, and V3, from the pulse signals Pd1, Pd2, and Pd3, and applies the drive signals to the piezoelectric actuator 3. Accordingly, the piezoelectric actuator 3 vibrates as described above, and the slider 2 moves according to the movement plan.

The duty is a ratio between Low and High of the pulse width and can be changed within a range of 0% to 50%. As the duties of the pulse signals Pd1, Pd2, and Pd3 approach 0%, the amplitudes of the drive signals V1, V2, and V3 become smaller, whereas as the duties of the pulse signals Pd1, Pd2, and Pd3 approach 50%, the amplitudes of the drive signals V1, V2, and V3 become larger. Accordingly, as the duties of the pulse signals Pd2 and Pd3 approach 0%, the velocity V of the slider 2 decreases, whereas as the duties of the pulse signals Pd2 and Pd3 approach 50%, the velocity V of the slider 2 increases. The duty of the pulse signal Pd2 is fixed to, for example, 50% in order to keep a voltage value constant.

As described above, in the first period D1, the control device 5 controls the movement of the slider 2 based on the position deviation 903 which is the difference between the first target position P1 and the position 902, which is the current position of the slider 2, and the velocity V of the slider 2, which is the actual velocity of the relative movement between the slider 2 and the piezoelectric actuators 3. In the first period D1, the velocity V is sufficiently high, and therefore, fluctuations are less likely to occur in the velocity V. Therefore, by controlling the drive of the piezoelectric actuator 3 using the velocity V, which is the actual velocity of the slider 2, in the first period D1, it is possible to stably and efficiently move the slider 2 toward the target stop position Pe.

In addition, the control device 5 controls the drive of the piezoelectric actuator 3 as follows in the second period D2. In the second period D2, the control device 5 controls the drive of the piezoelectric actuator 3 based on the difference between the second target position P2 and the current position of the slider 2 and any virtual velocity Vi of the slider 2 set as appropriate.

Specifically, as shown in FIG. 8, the control device 5 first generates a virtual velocity transition line G in which the velocity V at the end of the first period D1 is gradually decreased in virtual transition and becomes 0 (zero) at the end of the second period D2, and determines the virtual velocity Vi of the slider 2 in each control period based on the generated virtual velocity transition line G. In the shown example, the virtual velocity transition line G is formed as an S-shaped cubic curve, and a steep change in the velocity V is suppressed at the timing when the period switches from the first period D1 to the second period D2 and at the timing when the period switches from the second period D2 to the third period D3. Therefore, the movement of the slider 2 becomes smooth. However, the virtual velocity transition line G is not particularly limited, and may be, for example, a quadratic curve or a straight line.

As shown in FIG. 9, the position command generation unit 51 specifies the second target position P2 of the corresponding control period from the second target position P2 for each control period determined in advance, and generates a position command 901 in which the specified second target position P2 is determined. That is, the second target position P2 is updated in each control period. First, the position control unit 52 obtains the position deviation 903 by subtracting the position 902 of the slider 2 from the position command 901. Next, the position control unit 52 obtains a velocity command 904 by multiplying the position deviation 903 by a position loop proportional gain Kpp. The velocity control unit 53 first subtracts the virtual velocity Vi in the corresponding control period from the velocity command 904 to obtain the velocity loop command 906. That is, here, the actual velocity V of the slider 2 is not fed back, but the virtual velocity Vi determined based on the virtual velocity transition line G is fed back. Thereafter, the pulse signals Pd1, Pd2, and Pd3 are generated in the same manner as the first period D1 described above, and are applied to the piezoelectric actuator 3.

As described above, in the second period D2, the drive of the piezoelectric actuator 3 is controlled based on the position deviation 903, which is the difference between the second target position P2 and the current position of the slider 2, and any virtual velocity Vi that is set for the slider 2 as appropriate. The second period D2 is a period close to the target stop position Pe, the velocity V of the slider 2 is low, and fluctuations are more likely to occur in the velocity V. That is, there is a concern that the velocity V may fluctuate greatly in each control period. Therefore, if the velocity V is fed back, the movement of the slider 2 is more likely to become unstable due to the fluctuation of the velocity V. Therefore, in the second period D2 in which the velocity V is low, the movement of the slider 2 can be stabilized by using the stable virtual velocity Vi in virtual determination instead of the unstable velocity V. Therefore, it is possible to move the slider 2 toward the target stop position Pe in a shorter time and with high accuracy.

In addition, the control device 5 controls the drive of the piezoelectric actuator 3 as follows in the third period D3. In the third period D3, the control device 5 sets the virtual velocity Vi to 0 (zero), and controls the drive of the piezoelectric actuator 3 based on the difference between the target stop position Pe and the current position of the slider 2 until the slider 2 stops at the target stop position Pe. That is, the drive of the piezoelectric actuator 3 is controlled only by the position control without performing the velocity control.

Specifically, as shown in FIG. 10, the position command generation unit 51 generates a position command 901 that determines the target stop position Pe in each control period. First, the position control unit 52 obtains the position deviation 903 by subtracting the position 902 of the slider 2 from the position command 901. Next, the position control unit 52 obtains a velocity command 904 by multiplying the position deviation 903 by a position loop proportional gain Kpp. The velocity control unit 53 first subtracts the virtual velocity Vi(= 0) from the velocity command 904 to obtain a velocity loop command 906. That is, here, the actual velocity V of the slider 2 is not fed back, but the virtual velocity Vi(= 0) is fed back. Thereafter, the pulse signals Pd1, Pd2, and Pd3 are generated in the same manner as the first period D1 described above, and are applied to the piezoelectric actuator 3.

In this manner, in the third period D3, the virtual velocity Vi is set to 0 (zero), and the drive of the piezoelectric actuator 3 is controlled based on the difference between the target stop position Pe and the current position of the slider 2 until the slider 2 stops at the target stop position Pe. That is, the control device 5 controls the drive of the piezoelectric actuator 3 only by the position control without performing the velocity control. The third period D3 is a period immediately before the slider 2 reaches the target stop position Pe, the velocity V of the slider 2 is low, and fluctuations are more likely to occur in the velocity V. That is, there is a concern that the velocity V may fluctuate greatly in each control period. Therefore, if the velocity V is fed back, the movement of the slider 2 is more likely to become unstable due to the fluctuation of the velocity V. Therefore, in the third period D3 in which the velocity V is low, the movement of the slider 2 can be stabilized by using the virtual velocity Vi set to 0 (zero) instead of the unstable velocity V. Therefore, reciprocating movement or the like across the target stop position Pe is less likely to occur, and the slider 2 can be stopped at the target stop position Pe in a shorter time and with high accuracy. "The slider 2 is stopped at the target stop position Pe" described above means not only the case where the actual stop position of the slider 2 and the target stop position Pe coincide with each other but also the case where an error within an allowable range occurs between the actual stop position of the slider 2 and the target stop position Pe.

The drive device 1 has been described above. The control device 5 included in such a drive device 1, which includes the piezoelectric actuator 3 as a vibrating body and the slider 2 as a contact body in contact with the piezoelectric actuator 3, is a control device 5 that causes the piezoelectric actuator 3 and the slider 2 to perform relative movement to each other by vibrating the piezoelectric actuator 3. A period D from the start of the relative movement until the slider 2 reaches the target stop position Pe includes a first period D1 and a second period D2 subsequent to the first period D1. In the first period D1, the drive of the piezoelectric actuator 3 is controlled based on a difference between the first target position P1 located before the target stop position Pe and a current position of the slider 2, and the velocity V, which is an actual velocity of the relative movement. In the second period D2, the drive of the piezoelectric actuator 3 is controlled based on a difference between the current position of the slider 2 and the second target position P2, which is located closer to the target stop position Pe than is the first target position P1, and any virtual velocity Vi that is a virtual velocity set for the relative movement. According to such a configuration, the movement of the slider 2 in the vicinity of the target stop position Pe is stabilized, and reciprocating movement or the like across the target stop position Pe is less likely to occur. Therefore, it is possible to stop the slider 2 at the target stop position Pe in a shorter time and with high accuracy.

As described above, the first target position P1 is determined for each control period. According to such a configuration, it is possible to more reliably move the slider 2 toward the target stop position Pe.

As described above, the second target position P2 is located between the first target position P1 and the target stop position Pe, and is determined for each control period. According to such a configuration, it is possible to more reliably move the slider 2 toward the target stop position Pe.

As described above, the period D further includes the third period D3 subsequent to the second period D2, and the control device 5 controls the drive of the piezoelectric actuator 3 based on the difference between the target stop position Pe and the current position of the slider 2 in the third period D3. According to such a configuration, the movement of the slider 2 in the vicinity of the target stop position Pe is stabilized, and reciprocating movement or the like across the target stop position Pe is less likely to occur. Therefore, it is possible to stop the slider 2 at the target stop position Pe in a shorter time and with high accuracy.

Further, the first period D1 is determined based on at least one of the velocity V, which is the velocity of the relative movement, the movement distance L to the target stop position Pe, and the movement time T to the target stop position Pe. According to such a configuration, it is possible to easily and appropriately determine the first period D1.

### Second Embodiment

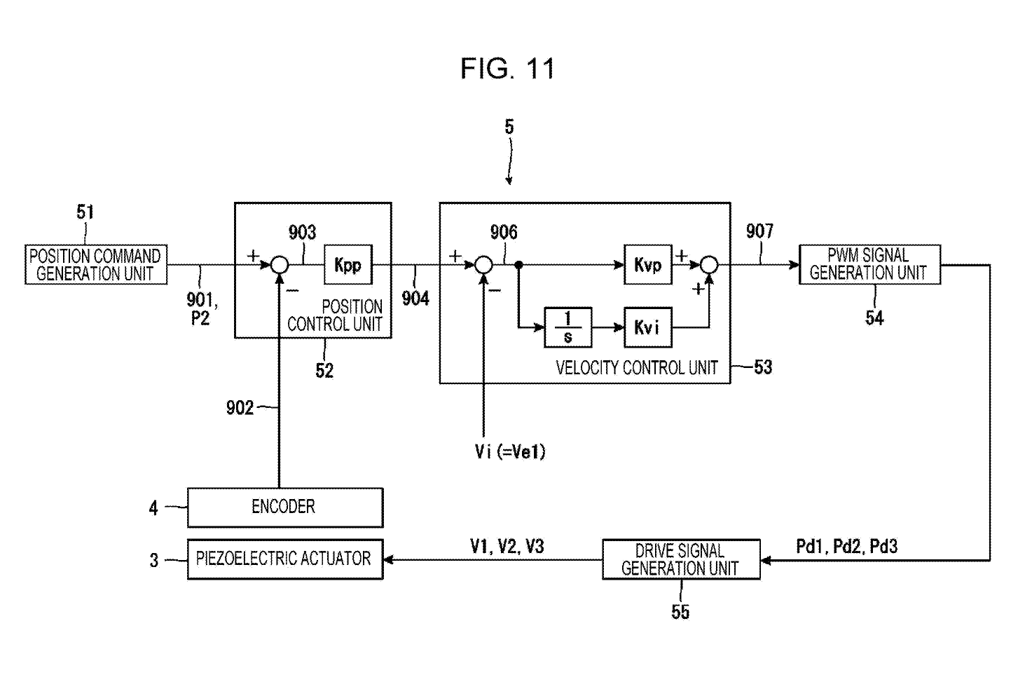

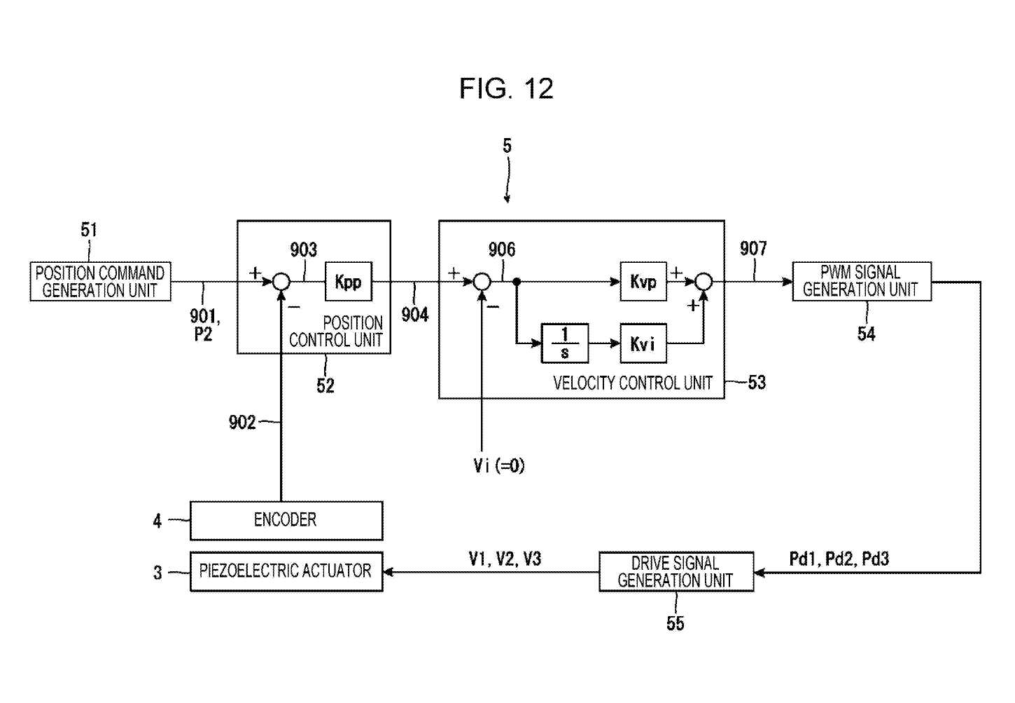

FIG. 11 is a block diagram showing a method of controlling the piezoelectric actuator in the second period when a velocity Ve1 is higher than an assumed range. FIG. 12 is a block diagram showing a method of controlling the piezoelectric actuator in the second period when the velocity Ve1 is lower than the assumed range.

The drive device 1 of the present embodiment is the same as that of the first embodiment described above except that the method of controlling the piezoelectric actuator 3 in the second period D2 is different. In the following description, the present embodiment will be described focusing on differences from the first embodiment described above, and the description of the same matters will be omitted. In each of the drawings according to the present embodiment, the same reference numerals are assigned to the same configurations as those of the above-described embodiment.

In the first embodiment described above, the control device 5 changes the method of controlling the piezoelectric actuator 3 in the second period D2 in accordance with the actual velocity V of the slider 2 at the end of the first period D1. Specifically, the control device 5 determines whether or not the velocity Ve1 at the end of the first period D1 is located within a preset assumed range. When the velocity Ve1 is within the assumed range, the control device 5 controls the drive of the piezoelectric actuator 3 in the same manner as in the first embodiment described above. On the other hand, when the velocity Ve1 is higher than the assumed range, as shown in FIG. 11, the control device 5 sets the virtual velocity Vi in each control period to the same value as the velocity Ve1 and controls the drive of the piezoelectric actuator 3. On the other hand, when the velocity Ve1 is lower than the assumed range, as shown in FIG. 12, the control device 5 sets the virtual velocity Vi of each control period to 0 (zero), and controls the drive of the piezoelectric actuator 3. In this way, by changing the method of controlling the piezoelectric actuator 3 in the second period D2 in accordance with the velocity V at the end of the first period D1, the movement of the slider 2 becomes more stable, and the slider 2 can be stopped at the target stop position Pe in a shorter time.

Also with such second embodiment, it is possible to exhibit the same effects as those of the above-described first embodiment.

### Third Embodiment

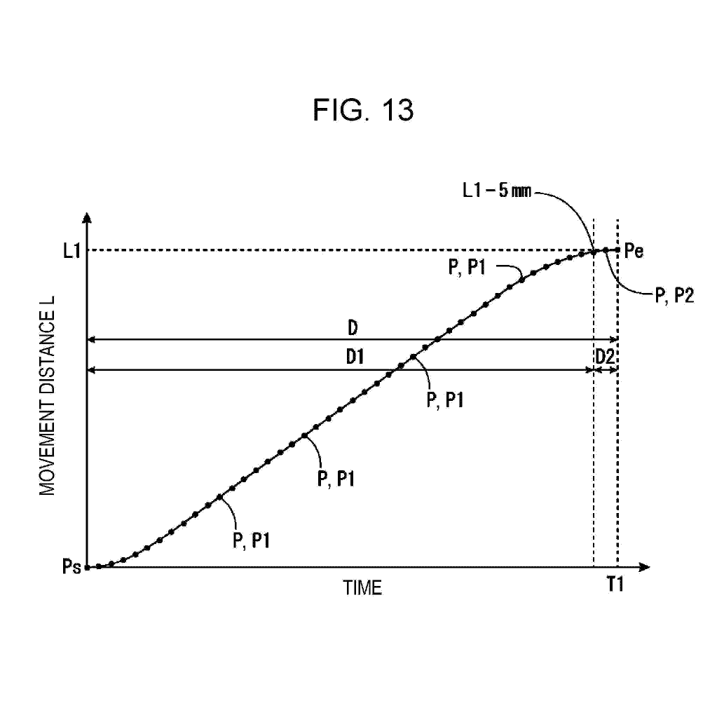

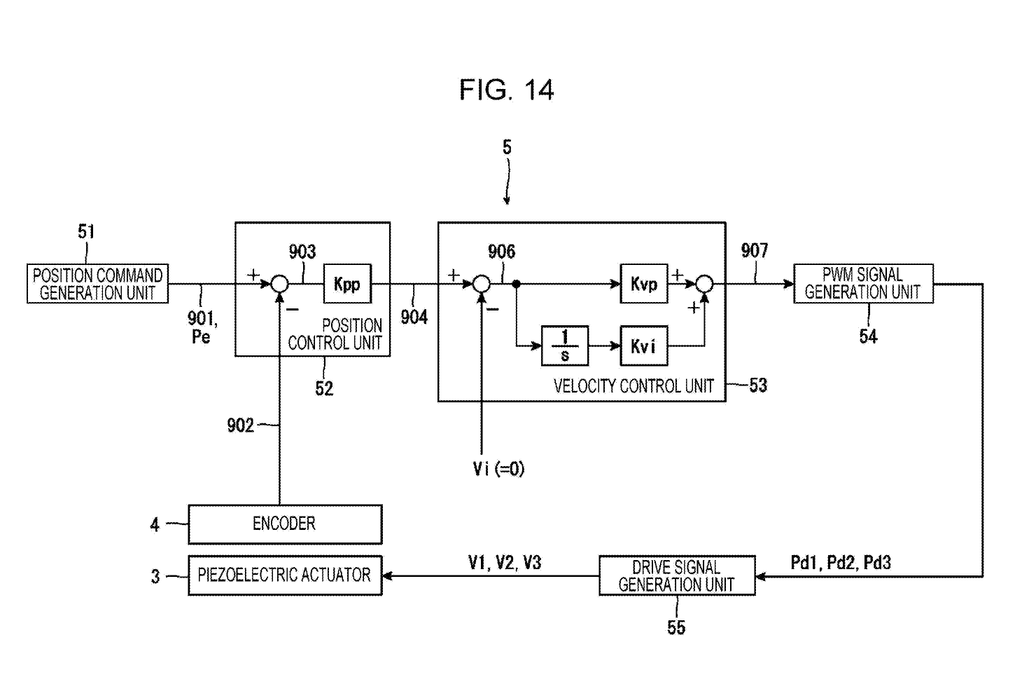

FIG. 13 is a graph showing an example of a position profile according to a third embodiment. FIG. 14 is a block diagram showing a method of controlling the piezoelectric actuator 3 in the second period.

The drive device 1 of the present embodiment is the same as that of the first embodiment described above except that the third period D3 is not included in the method of controlling the piezoelectric actuator 3 in the present embodiment. In the following description, the present embodiment will be described focusing on differences from the first embodiment described above, and the description of the same matters will be omitted. In each of the drawings according to the present embodiment, the same reference numerals are assigned to the same configurations as those of the above-described embodiments.

In the present embodiment, as shown in FIG. 13, the control device 5 divides the period D into the first period D1 and the second period D2. In the first period D1, the control device 5 controls the drive of the piezoelectric actuator 3 by the same method as that in the first embodiment described above. On the other hand, in the second period D2, as shown in FIG. 14, the control device 5 sets the virtual velocity Vi to 0 (zero), and controls the drive of the piezoelectric actuator 3 based on the difference between the target stop position Pe and the position 902, which is the current position of the slider 2, until the slider 2 stops at the target stop position Pe. That is, the second target position P2 is set as the target stop position Pe, and the drive of the piezoelectric actuator 3 is controlled by the same method as in the third period D3 of the first embodiment described above. Such a method is effective, for example, when the first period D1 can be set to be longer than that in the above-described first embodiment, that is, when fluctuations in the velocity of the slider 2 at low velocity are less likely to occur as compared to the above-described first embodiment. According to such a method, the movement of the slider 2 is stabilized even at low velocity, and the slider 2 can be stopped at the target stop position Pe in a shorter time.

As described above, in the control device 5 of the present embodiment, the second target position P2 is the target stop position Pe. According to such a configuration, the movement of the slider 2 is stabilized even at low velocity, and the slider 2 can be stopped at the target stop position Pe in a shorter time.

Also with such a third embodiment, it is possible to exhibit the same effects as those of the above-described first embodiment.

### Fourth Embodiment

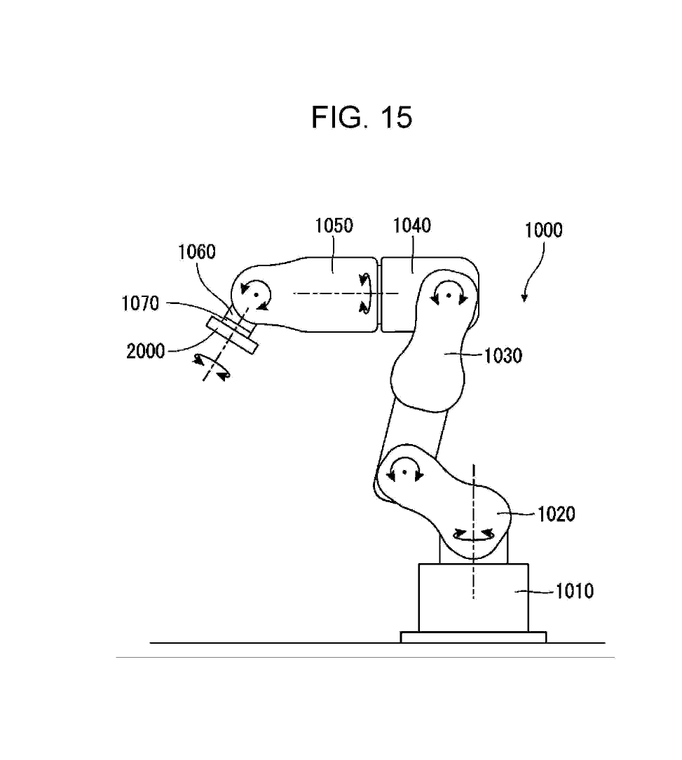

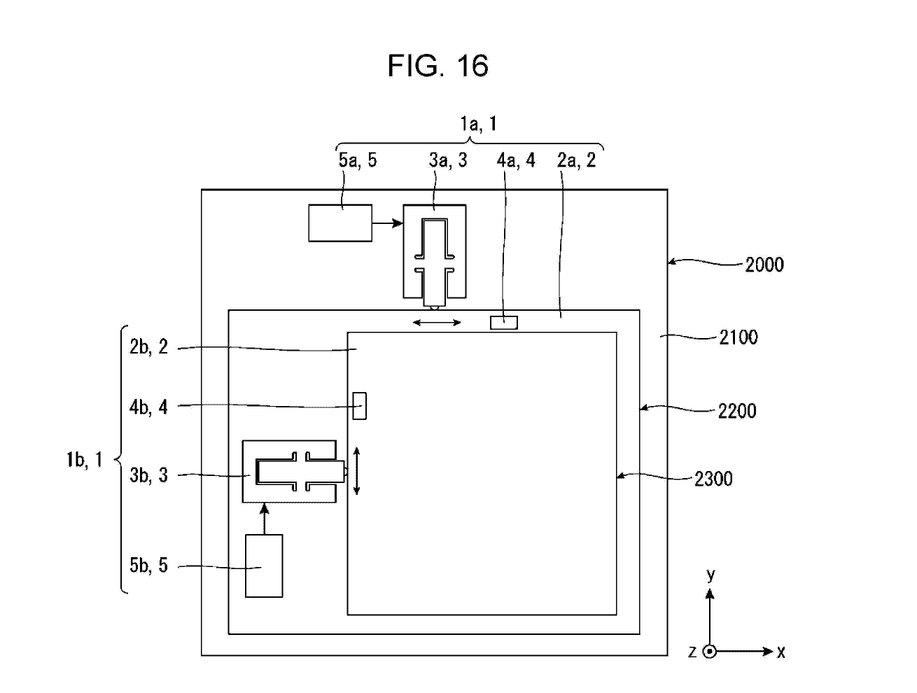

FIG. 15 is a side view showing a robot according to a fourth embodiment. FIG. 16 is a plan view showing a movable stage.

A robot 1000 shown in FIG. 15 can perform work such as feeding, removing, transporting, and assembling precision devices and components constituting the same, or the like. The robot 1000 is a six-axis robot and includes a base 1010 fixed to a floor or a ceiling, an arm 1020 rotatably coupled to the base 1010, an arm 1030 rotatably coupled to the arm 1020, an arm 1040 rotatably coupled to the arm 1030, an arm 1050 rotatably coupled to the arm 1040, an arm 1060 rotatably coupled to the arm 1050, an arm 1070 rotatably coupled to the arm 1060, and a movable stage 2000 mounted on the arm 1070.

Hereinafter, for convenience of description, three axes orthogonal to each other are referred to as an x-axis, a y-axis, and a z-axis, and a direction along the x-axis is referred to as an x-axis direction, a direction along the y-axis is referred to as a y-axis direction, and a direction along the z-axis is referred to as a z-axis direction. A coordinate system constituted by the x-axis, the y-axis, and the z-axis is different from the above-described coordinate system constituted by the X-axis, the Y-axis, and the Z-axis.

The movable stage 2000 shown in FIG. 16 includes a base 2100, a first movable portion 2200 that moves in the x-axis direction with respect to the base 2100, and a second movable portion 2300 that moves in the y-axis direction with respect to the first movable portion 2200. Each of the first movable portion 2200 and the second movable portion 2300 is constituted by the drive device 1. Hereinafter, in order to distinguish the two drive devices 1, "a" is added to the end of the reference numeral of the drive device 1 constituting the first movable portion 2200, and "b" is added to the end of the reference numeral of the drive device 1 constituting the second movable portion 2300.

A drive device 1a includes a stage-like slider 2a which linearly moves in the x-axis direction with respect to the base 2100, a piezoelectric actuator 3a which moves the slider 2a in the x-axis direction, an encoder 4a which detects a position of the slider 2a, and a control device 5a which controls the drive of the piezoelectric actuator 3a. The control device 5a controls the drive of the piezoelectric actuator 3a in the same manner as in the first to third embodiments described above.

A drive device 1b includes a stage-like slider 2b which linearly moves in the y-axis direction with respect to the slider 2a, a piezoelectric actuator 3b which moves the slider 2b in the y-axis direction, an encoder 4b which detects a position of the slider 2b, and a control device 5b which controls the drive of the piezoelectric actuator 3b. The control device 5b controls the drive of the piezoelectric actuator 3b in the same manner as in the first to third embodiments described above.

According to such movable stage 2000, each of the sliders 2a and 2b can be stopped at the target stop position Pe in a short time and with high accuracy.

As described above, the robot 1000 includes the movable stage 2000 that includes the piezoelectric actuator 3 as a vibrating body, the slider 2 as a contact body in contact with the piezoelectric actuator 3, and the control device 5 that causes the piezoelectric actuator 3 and the slider 2 to perform relative movement to each other by vibrating the piezoelectric actuator 3. A period D from the start of the relative movement until the slider 2 reaches the target stop position Pe includes a first period D1 and a second period D2 subsequent to the first period D1. In the first period D1, the control device 5 controls the drive of the piezoelectric actuator 3 based on a difference between the first target position P1 located before the target stop position Pe and a current position of the slider 2, and the velocity V, which is an actual velocity of the relative movement. In the second period D2, the control device 5 controls the drive of the piezoelectric actuator 3 based on a difference between the current position of the slider 2 and the second target position P2, which is located closer to the target stop position Pe than is the first target position P1, and any virtual velocity Vi that is a virtual velocity set for the relative movement. According to such a configuration, the movement of the slider 2 in the vicinity of the target stop position Pe is stabilized, and reciprocating movement or the like across the target stop position Pe is less likely to occur. Therefore, it is possible to stop the slider 2 at the target stop position Pe in a shorter time and with high accuracy.

As described above, the control device and the robot according to the present disclosure have been described based on the shown embodiments, but the present disclosure is not limited thereto, and the configuration of each unit can be replaced with any configuration having the same function. Additionally, any other configuration may be added to the present disclosure. In addition, each embodiment may be combined as appropriate.

1. A control device in a drive device including a vibrating body and a contact body in contact with the vibrating body, the control device being configured to cause the vibrating body and the contact body to perform relative movement to each other by vibrating the vibrating body, wherein
a period from start of the relative movement until the contact body reaches a target stop position includes a first period and a second period subsequent to the first period,
the control device controls, in the first period, drive of the vibrating body based on a difference between a first target position located before the target stop position and a current position, and an actual velocity of the relative movement, and
the control device controls, in the second period, the drive of the vibrating body based on a difference between the current position and a second target position located closer to the target stop position than is the first target position, and any virtual velocity that is set for the relative movement.

2. The control device according to claim 1, wherein the first target position is determined in each control period.

3. The control device according to claim 1, wherein the second target position is the target stop position.

4. The control device according to claim 1, wherein the second target position is located between the first target position and the target stop position, and is determined in each control period.

5. The control device according to claim 4, wherein
the period further includes a third period subsequent to the second period, and
in the third period, the drive of the vibrating body is controlled based on a difference between the target stop position and the current position.

6. The control device according to claim 1, wherein the first period is determined based on at least one of a velocity of the relative movement, a movement distance to the target stop position, and a movement time to the target stop position.

7. The control device according to claim 1, wherein
the first target position is a target position determined in each control period, and is determined based on at least one of a velocity of the relative movement, a movement distance to the target stop position, and a movement time to the target stop position,
the second target position is a target position that is located between the first target position and the target stop position and is determined in each control period,
the period further includes a third period subsequent to the second period, and
in the third period, a velocity of the relative movement is set to zero, and the drive of the vibrating body is controlled based on a difference between the target stop position and the current position.

8. A robot comprising:
a movable stage that includes a vibrating body, a contact body in contact with the vibrating body, and a control device that causes the vibrating body and the contact body to perform relative movement to each other by vibrating the vibrating body, wherein
a period from start of the relative movement until the contact body reaches a target stop position includes a first period and a second period subsequent to the first period, and
the control device controls, in the first period, drive of the vibrating body based on a difference between a first target position located before the target stop position and a current position, and an actual velocity of the relative movement, and controls, in the second period, the drive of the vibrating body based on a difference between the current position and a second target position located closer to the target stop position than is the first target position, and any virtual velocity that is set for the relative movement.
